(19) United States
(12) Patent Application Publication
(10) Pub. No.: US 2006/0093773 A1
(43) Pub. Date: May 4, 2006

(54) Foam with adhesive material tape

(76) Inventors: Rene Dujardin, Racren (BE); Jean-Pierre Mayeres, Eupen (BE)

Correspondence Address: MELVIN I. STOLTZ, ESQ., 51 CHERRY STREET, MILFORD, CT, 06460, US

(21) Appl. No.: 10/520,373

(22) PCT Filed: Jul. 16, 2003
(86) PCT No.: PCT/EP03/50311

§ 371 Date: Sep. 2, 2005

(30) Foreign Application Priority Data
Jul. 19, 2002 (EP) 02016095.8

(51) Int. Cl. B32B 33/00

(52) U.S. Cl. 428/40.1

(57) ABSTRACT

The invention concerns a foam comprising at least an adhesive material applied in the form of a tape on one surface of the freshly extruded foam. The invention is characterized in that the tape of adhesive material is divided into several strips, a first part of said strips comprising the adhesive material and a second part of said strips not comprising adhesive material, and in that the strips comprising adhesive material and the strips not comprising adhesive material are alternately arranged on the foam surface and in that the surface in contact with the adhesive material is uniform after the foam has been degassed.

The present invention relates to a foam with a strip of adhesive material.

Polymer foams are well known and the field of their application is huge. For producing such foams, polymers and, where appropriate, additives are mixed and plastified under pressure at high temperature. A pressurized foaming gas is, injected into this mixture, which is subsequently extruded through a die and cooled. On its extrusion into the atmosphere the mixture undergoes a pressure drop which gives rise to the formation of gas bubbles within the mixture, thereby causing the foam to form. The foam is subsequently degassed.

In order to be able to attach the foam to a support an adhesive material is applied in a strip to one face of the foam. Generally a self-adhesive hot-melt glue is applied in the melted state as a strip of adhesive material to a surface of the freshly extruded foam. The strip of adhesive material is covered with a release paper, which serves for protection in transit. The application of the adhesive to the freshly extruded foam gives rise, however, to irregularities on the surface of the foam at the site where the strip of adhesive material has been applied. It is found that, after the foam has been degassed, the surface of the foam covered with the strip of adhesive material is uneven and exhibits bumps. As well as their unattractive esthetic appearance, these surface irregularities result in nonuniform adhesion of the foam to a substrate.

For certain applications, in the case for example where uniform adhesion of the foam to a substrate is desired, a foam is needed which has a smooth surface, free from irregularities. In order to obtain such a foam, which, in the degassed state, comprises a smooth adhesive surface with no bumps, the strip of adhesive material is applied to a surface of the foam after said foam has been degassed. Consequently it is necessary to store the foam after extrusion until it is degassed. Only then is the strip of adhesive material applied to it. The additional handling of the foam which is needed in order to obtain an adhesive surface free from irregularities gives rise, however, to a higher production cost.

The object of the present invention is to provide a foam with a strip of adhesive material applied to a surface of the freshly extruded foam, in which the covered surface does not exhibit irregularities after degassing.

In accordance with the invention this objective is achieved by a foam comprising at least one adhesive material applied in a strip to a surface of the freshly extruded foam. The foam being characterized in that the strip of adhesive material is divided into several tracks, a first set of these tracks comprising the adhesive material and a second set of these tracks not comprising adhesive material, in that the tracks comprising the adhesive material and the tracks not comprising adhesive material are disposed alternately on the surface of the foam, and in that the surface in contact with the adhesive material is free from irregularities after the foam has been degassed.

A foam of this kind comprises a strip of adhesive material applied to a surface of the freshly extruded foam, the strip of adhesive material being divided into several tracks, with a track without adhesive material being disposed in each case between two tracks comprising the adhesive material. It is possible in this way to obtain a surface in contact with the strip of adhesive material that is smooth and free from irregularities after the foam has been degassed. An appearance smooth and free from irregularities means, in the context of the present invention, a surface appearance which is in fact very similar to the appearance of the surface of a foam which has not been coated with adhesive material.

A strip of adhesive material with several separate adhesive tracks allows more uniform degassing of the foam. The reason for this is that, since the strip of adhesive material comprises tracks without adhesive material disposed between two tracks comprising adhesive material, the degassing of the foam is far less hindered by the strip of adhesive material applied to the freshly extruded foam. Deformation of the surface of the foam covered with the strip of adhesive material in the course of degassing is therefore prevented, and a foam without surface irregularities is obtained after degassing. This avoids the need for interim storage of the foam and for subsequent application of the strip of adhesive material. Consequently the production costs of a foam with a surface free from irregularities are reduced.

In order to prevent sagging of the foam, the present invention proposes using a strip of adhesive material alternately comprising tracks with the adhesive material and tracks without adhesive material.

Consequently one merit of the invention is to have discovered that the application of a strip of adhesive material to a freshly extruded foam brings about a local change in the permeability of the foam with respect to the foaming gas. This local change in permeability results in sagging of the foam in contact with the adhesive, thereby forming an irregular surface which exhibits bumps after degassing.

The surface irregularities prevent uniform contact between the adhesive material and the substrate on which the foam is glued. Since, in the case of a foam according to the invention, these surface irregularities are prevented, improved contact is obtained between the adhesive material and the substrate. The substrate adhesion of a foam according to the invention is consequently better. To obtain the same adhesive force it is therefore possible to reduce the amount and/or the surface area of adhesive material applied, which constitutes an economic advantage.

The adhesive material is advantageously a self-adhesive hot-melt glue which is applied in the melted state to the foam.

By virtue of the alternation of tracks comprising the adhesive material and tracks without adhesive material the amount of heat applied locally to the foam is reduced. The reason for this is that, by virtue of the tracks without adhesive material on either side of tracks comprising the adhesive material, the adhesive material cools more quickly. The risk of the foam sagging is consequently greatly reduced, or even negligible. The result is a regular foam surface, i.e., a surface without bumps, after the foam has been degassed.

The tracks may be continuous or discontinuous. They may be straight, wavy or zigzag. In fact their form is not really important.

The tracks featuring adhesive material and the tracks without adhesive material are preferably parallel.

Preferably the ratio between the surface areas occupied by the tracks comprising the adhesive material and the surface areas occupied by the tracks without adhesive material is situated at between 0.2 and 5, preferably between 0.5 and 2. These surface area ratios depend in general on the polymer, on the type and amount of additives incorporated in the foam, on the density of the foam, and on the foaming gas. More preferably the ratio is 1; in other words the surface area of the tracks comprising the adhesive material is identical to that of the tracks without adhesive material.

The tracks preferably have a width of between 0.5 and 15 mm and preferably between 2 and 8 mm.

Commonly the width of the tracks comprising the adhesive material is identical to that of the tracks without adhesive material.

Advantageously one strip comprises between 3 and 15 tracks.

The strip of adhesive material preferably comprises a release paper for protecting the strip of adhesive material. Before the foam is glued to a substrate the release paper is removed, thereby exposing the adhesive material applied to the foam.

The foam is preferably a polymer foam selected from the group consisting of polyolefins, metallocenes, polystyrenes, copolymers thereof, and mixtures thereof.

The foam may comprise customary additives such as, for example, cell stabilizers, nucleators, flame retardants, UV stabilizers, pigments, lubricants, antioxidants, infrared absorbers, and mixtures thereof.

The foaming gas is advantageously a foaming gas selected from the group consisting of alkanes, HFCs, CO₂, N₂, Ar, and mixtures thereof.

The present invention likewise provides a process for producing a foam, comprising the steps of:
producing foam by extrusion,
applying, to a surface of the freshly extruded foam, an adhesive material in a strip, the strip of adhesive material being divided into several tracks, a first set of these tracks comprising the adhesive material and a second set of these tracks not comprising adhesive material, the tracks comprising the adhesive material and the tracks not comprising adhesive material being disposed alternately on the surface of the foam,
degassing the foam, to give a foam comprising a surface in contact with the adhesive material that is free from irregularities after degassing.

In a first advantageous embodiment the adhesive material is a self-adhesive hot-melt glue, which is melted in a melting vessel and pumped through an injection nozzle in order to lay down the tracks comprising the adhesive material.

According to one preferred embodiment the tracks comprising the adhesive material are laid down on a release paper which is subsequently applied to a surface of the foam. The release paper can be removed before the foam is attached to a substrate.

The adhesive material may be laid down either by a device which is in contact with the release paper or with a device which is not in contact with the release paper. In this latter case the release paper is guided a few centimeters below the nozzle and the adhesive material forms filaments which are laid down on the paper.

According to another preferred embodiment the tracks comprising the adhesive material are laid down continuously on a rotating transfer roller, which is preferably thermostated and antiadhesive, and which is in contact with the surface of the foam.

Advantageously a gas, preferably nitrogen, is injected into the melted adhesive material prior to its application to the foam. In this way it is possible to obtain a foamed structure of the tracks featuring adhesive material. The results are a greater contact surface area for a given amount of glue, and a greater track thickness for improved spread during setting on a rough substrate.

One advantageous embodiment of the invention is described below by way of example, with reference to the attached figures, in which:

FIG. 1: represents a sectional view of a foam according to the state of the art, before the foam has been degassed;

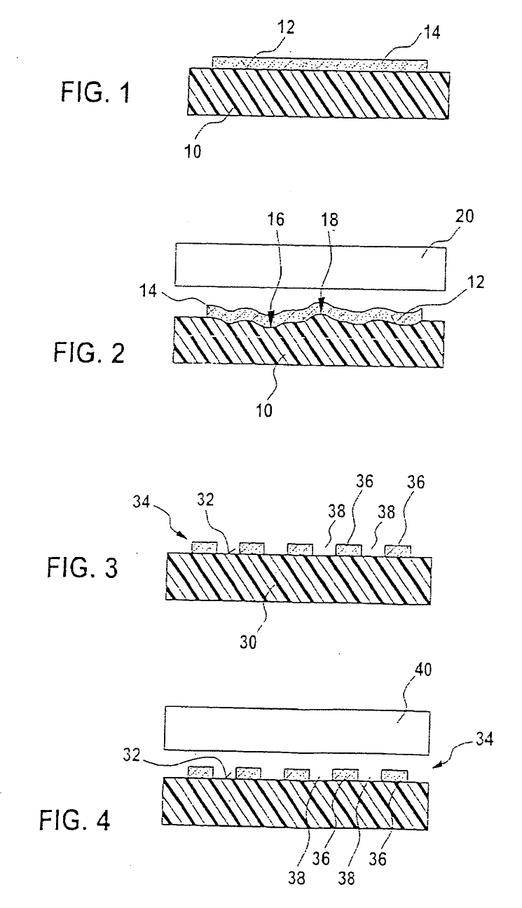

FIG. 2: represents a sectional view of a foam according to the state of the art, after the foam has been degassed;

FIG. 3: represents a sectional view of a foam according to the invention, before the foam has been degassed;

FIG. 4: represents a sectional view of a foam according to the invention, after the foam has been degassed;

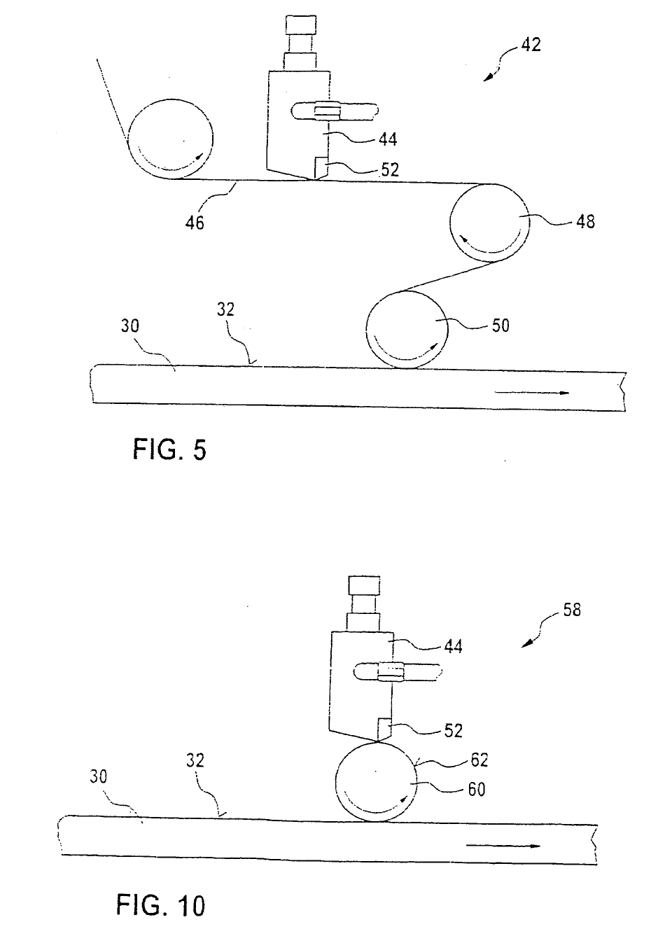

FIG. 5: represents an installation for applying a strip of adhesive material to a freshly extruded foam;

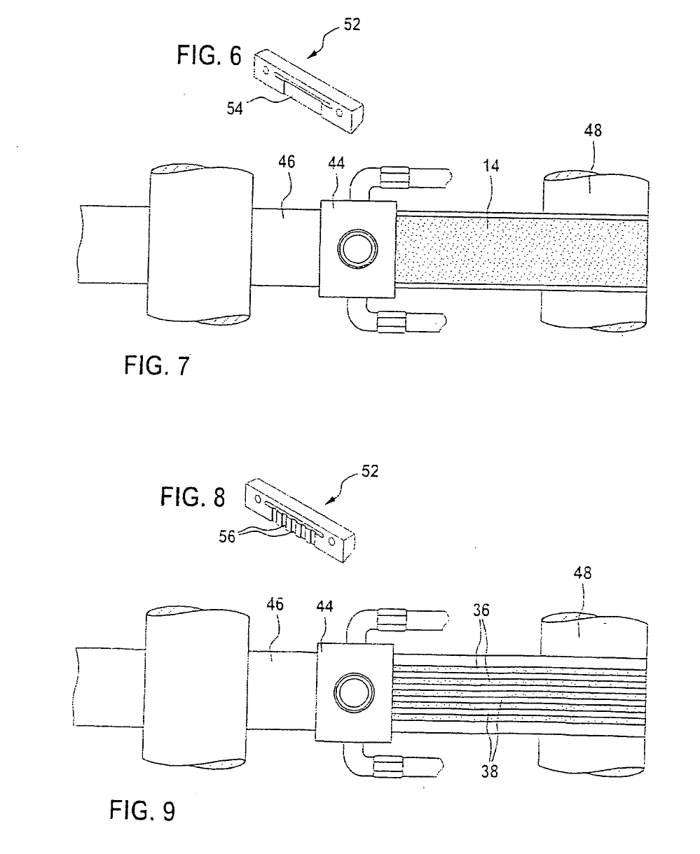

FIG. 6: represents a diagrammatic view of a nozzle head according to the state of the art;

FIG. 7: represents a view onto a strip of adhesive material laid down by means of the nozzle head of FIG. 6;

FIG. 8: represents a diagrammatic view of a nozzle head according to the invention; and

FIG. 9: represents a view onto a strip of adhesive material laid down by means of the nozzle head of FIG. 8; and

FIG. 10: represents another embodiment of an installation for applying a strip of adhesive material to a freshly extruded foam.

In the figures the same references designate elements which are identical or similar.

FIG. 1 shows a section through a foam 10 according to the state of the art, with a surface 12 to which a strip of adhesive material 14 has been applied prior to degassing. FIG. 2 shows the same foam 10 after the degassing of the foam 10. The surface 12 of the foam 10 has sagged, is rough and contains hollows 16 and humps 18. The roughness in the surface 12 prevents effective adhesion of the surface 12 of the foam 10 to a substrate 20.

FIG. 3 shows a section of a foam 30 with a surface 32 to which a strip of adhesive material 34 according to the invention has been applied. The strip of adhesive material 34 comprises alternately tracks with the adhesive material 36 and tracks without adhesive material 38. FIG. 4 shows the same foam 30 after the degassing of the foam 30. The surface 32 of the foam does not exhibit irregularities. The high quality of the surface 32 allows effective adhesion of the foam 30 to a substrate 40.

FIG. 5 shows an installation 42 for applying a strip of adhesive material to a freshly extruded foam. An adhesive material, preferably a self-adhesive hot-melt glue, is melted in a melting vessel (not shown) and is brought to a nozzle 44. The adhesive material is laid down by the nozzle 44 onto a release paper 46 which runs below the nozzle 44. The release paper 46 is guided by one or more guide rollers 48 and is applied, with its face comprising the adhesive material, to a surface 32 of a freshly extruded foam 30 via a transfer roller 50. The nozzle 44 comprises a nozzle head 52 for laying down a strip of adhesive material on the release paper.

A nozzle head 52 according to the state of the art is shown in FIG. 6 and the strip of adhesive material laid down by means of this nozzle head 52 is shown in FIG. 7. The nozzle head 52 comprises a wide aperture 54 for laying down a wide strip of adhesive material 14 on the release paper 46.

A nozzle head 52 according to the invention is shown in FIG. 8 and the strip of adhesive material laid down by means of this nozzle head is shown in FIG. 9. The nozzle head 52 comprises a plurality of apertures 56 for laying down a plurality of tracks featuring adhesive material 36 on the release paper 46. The tracks featuring adhesive material 36 are separated in each case by a track without adhesive material 38.

FIG. 10 shows another embodiment of an installation 58 for applying a strip of adhesive material to a freshly extruded foam. According to this embodiment the strip of adhesive material is laid down on a transfer roller 60, which is thermostated and antiadhesive, and which contacts a surface 32 of the freshly extruded foam 30.

In this way the tracks featuring adhesive material are laid down by the nozzle head 52 of the nozzle 44 on a circumferential surface 62 of the transfer roller 60 and then are transferred to the surface 32 of the freshly extruded foam 30.

1. A foam comprising at least one adhesive material applied in a strip to a surface of the freshly extruded foam, characterized in that the strip of adhesive material is divided into several tracks, a first set of these tracks comprising the adhesive material and a second set of these tracks not comprising adhesive material, in that the tracks comprising the adhesive material and the tracks not comprising adhesive material are disposed alternately on the surface of the foam, and in that the surface in contact with the adhesive material is free from irregularities after the foam has been degassed.

2. The foam defined in claim 1, wherein the adhesive material is a self-adhesive hot-melt glue.

3. The foam defined in claim 1 wherein the tracks are continuous or discontinuous.

4. The foam defined in claim 1, wherein the tracks are straight, wavy or zigzag.

5. The foam defined in claim 1, wherein the tracks are parallel.

6. The foam defined in claim 1, wherein the ratio between the surface areas of the tracks comprising the adhesive material and the surface areas of the tracks not comprising adhesive material is situated between 0.2 and 5, preferably between 0.5 and 2.

7. The foam defined in claim 1, wherein the tracks have a width of between 0.5 and 15 mm. preferably between 2 and 8 mm.

8. The foam defined in claim 1, wherein the strip of adhesive material comprises between 3 and 16 tracks.

9. The foam defined in claim 1, wherein the strip of adhesive material is covered with a release paper.

10. The foam defined in claim 1, wherein the foam is a polymer foam selected from the group comprising polyolefins, metallocenes, polystyrenes, copolymers thereof, and mixtures thereof.

11. The process for producing a foam, comprising the steps of:
A. producing foam by extrusion,
B. applying, to a surface of the freshly extruded foam, and adhesive material in a strip, the strip of adhesive material being divided into several tracks, a first set of these tracks comprising the adhesive material and a second set of these tracks not comprising adhesive material, the tracks comprising the adhesive material and the tracks not comprising adhesive material being disposed alternately on the surface of the foam.
C. degassing the foam, to give a foam comprising a surface in contact with the adhesive material that is free from irregularities after degassing.

12. The process defined in claim 11, wherein the adhesive material is a self-adhesive hot-melt glue, the adhesive material being melted in a melting vessel and pumped through an injection nozzle for laying down the adhesive material in a strip on the freshly extruded foam.

13. The process defined in claim 11, wherein the adhesive material is laid down in a strip on a release paper which is subsequently applied to the surface of the foam.

14. The process defined in claim 11, wherein the adhesive material is laid down in a strip continuously on a rotating transfer roller which is in contact with the surface of the foam.

15. The process defined in claim 11, wherein a gas, preferably nitrogen is injected into the adhesive material.
